(19) United States
(12) Patent Application Publication
(10) Pub. No.: US 2010/0262776 A1
(43) Pub. Date: Oct. 14, 2010

(54) DATA DRIVE

(76) Inventor: Amir Navid, Sherman Oaks, CA (US)

Correspondence Address: CHRISTIE, PARKER & HALE, LLP, PO BOX 7068, PASADENA, CA, 91109-7068, US

(21) Appl. No.: 12/422,193

(22) Filed: Apr. 10, 2009

(51) Int. Cl. G06F 12/00; A63F 9/24; G06F 9/455

(52) U.S. Cl. 711/115; 463/44; 703/24; 711/E12.001; 711/E12.008

(57) ABSTRACT

A data drive for interfacing with an electronic device through a memory card reader is described. The memory card reader accepts a memory card, which stores data having a first format. The data drive includes a storage device for storing data having a second format, a connector that emulates the memory card's connections, an interface unit between the storage device and the connector, and a controller for controlling data transfers between the storage device and the interface unit. The interface unit converts data between the first and second formats. The data drive attaches to the memory card reader through the connector and transfers data between the storage device and the external device through the memory card reader. The storage device can be a hard disk drive, permitting a relatively inexpensive and large capacity storage area to be used to transfer data through the memory card reader.

### BACKGROUND OF THE INVENTION

Consumer electronic devices often require a huge storage space. For example, when users play games on video game consoles, they often need to save the video game data so that they can start at the point in the game where they left off. Still other applications for modern video game consoles, like photos, music, or downloaded games take up large amounts of space that cannot fit in the game console's internal storage. Further, it is desirable to have the storage device interface with standard computer interfaces such that the data can be stored on a computer or transmitted to other devices.

Nowadays, a memory card (e.g., Secure Digital (SD) card) is often used to store data for such devices as video game consoles, cameras, and the like. The memory cards are often expensive, and are limited in the amount of data that can be stored on them. For example, a typical memory card stores 1 gigabyte (GB) or 2 GB of data.

It is desirable to provide a device that can hold large amounts of additional data in a relatively inexpensive manner, and without having to manage dozens of little memory cards.

### SUMMARY OF THE INVENTION

In an exemplary embodiment according to the present invention, a data drive is provided. The data drive includes: a storage device for storing data having a second format; an interface unit for converting a format of the data between a first format of a memory card and the second format, the interface unit comprising a device that is insertable into an external memory card reader to emulate the memory card; and a controller for controlling data transfers between the storage device and the interface unit.

In another exemplary embodiment according to the present invention, a method of transferring data between a storage device and an external device having a memory card reader is provided. The memory card reader transfers data having a first format, while the storage device transfers data having a second format. The method includes reading and storing. The reading includes: reading first data having the second format from the storage device; converting the first data having the second format into first data having the first format; and storing the first data having the first format to the external device through the memory card reader. The storing includes: reading second data having the first format from the external device through the memory card reader; converting the second data having the first format into second data having the second format; and storing the second data having the second format to the storage device.

In yet another exemplary embodiment according to the present invention, a method of emulating a memory card to a memory card reader using a storage device is provided. The memory card stores data having a first format, while the storage device stores data having a second format. The method includes: coupling the storage device to the memory card reader using a connector emulating physical and electronic connections of the memory card; and interfacing the storage device with the connector, wherein the interfacing comprises converting a format of data between the first format and the second format.

### BRIEF DESCRIPTION OF THE DRAWINGS

The accompanying drawings illustrate embodiments of the present invention, and together with the description, serve to explain the principles of the embodiments of the present invention.

FIG. 1 is a block diagram of a data drive in an exemplary embodiment according to the present invention.

FIG. 2 is a perspective view of a data drive in an exemplary embodiment according to the present invention.

FIG. 3 is a side view of the data drive of FIG. 2 mounted on an external electronic device.

FIG. 4 is a front view of the data drive of FIG. 2 mounted on an external electronic device.

FIG. 5 is a front view of a data drive according to another exemplary embodiment of the present invention, mounted on an external electronic device.

FIG. 6 is a side view of a data drive coupled to an AC connector and mounted to an external electronic device in an exemplary embodiment according to the present invention.

FIG. 7 is another side view of the data drive of FIG. 6.

FIG. 8 is a schematic view of a data drive having a two-part design including a detachable mounting member according to an exemplary embodiment of the present invention.

### DETAILED DESCRIPTION

Now, exemplary embodiments of the present invention will be described in more detail with reference to the accompanying drawings.

In exemplary embodiments according to the present invention, a data drive including a hard drive to memory card adapter is provided. In one embodiment, the hard drive is a Hard Disk Drive (HDD). Also, in one embodiment, the memory card is Secure Digital (SD). However, the present invention is not limited to HDD or SD.

In an exemplary embodiment according to the present invention, the adapter functions according to the following. A memory card connector of the data drive is inserted into a memory card reader, which is itself connected to or is an internal component of an external electronic device such as a computer, camera, video game console, etc. It should be noted that while the term memory card “reader” is used, it is understood from common parlance that the device also functions as a memory card writer. The memory card connector is connected through the memory card adapter to an internal HDD of the data drive using an industry standard interface (e.g., through Integrated Device Electronics (IDE), Serial Advanced Technology Attachment (SATA), etc.). The HDD is able to read or write data through the memory card connector from or to the external device that the memory card reader is connected to. In essence, this allows the HDD to communicate with an external device by having the memory card connector emulate a memory card to the external device's memory card reader.

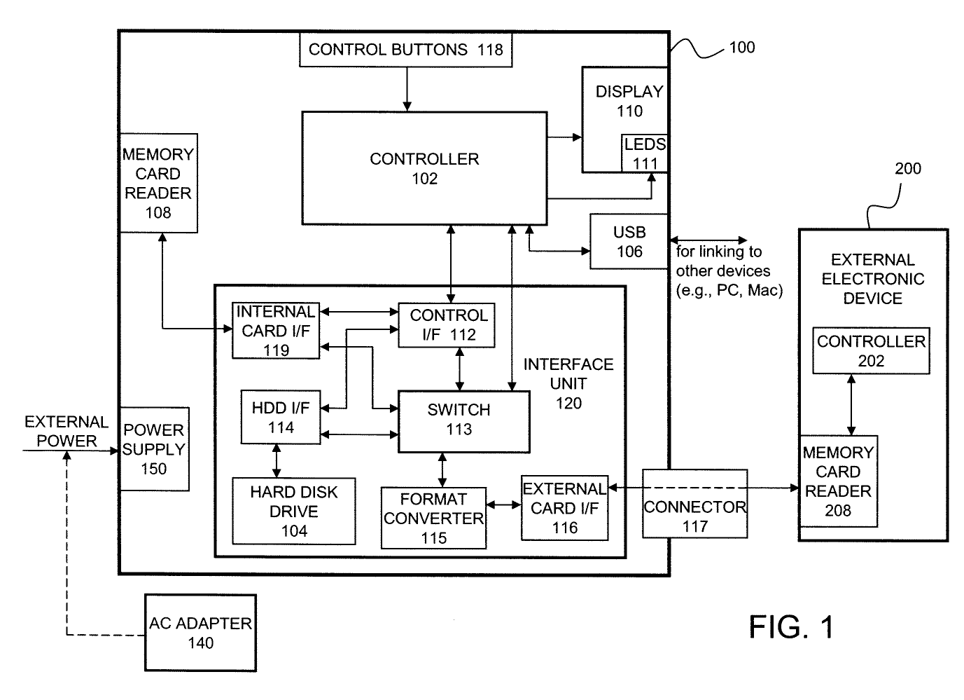

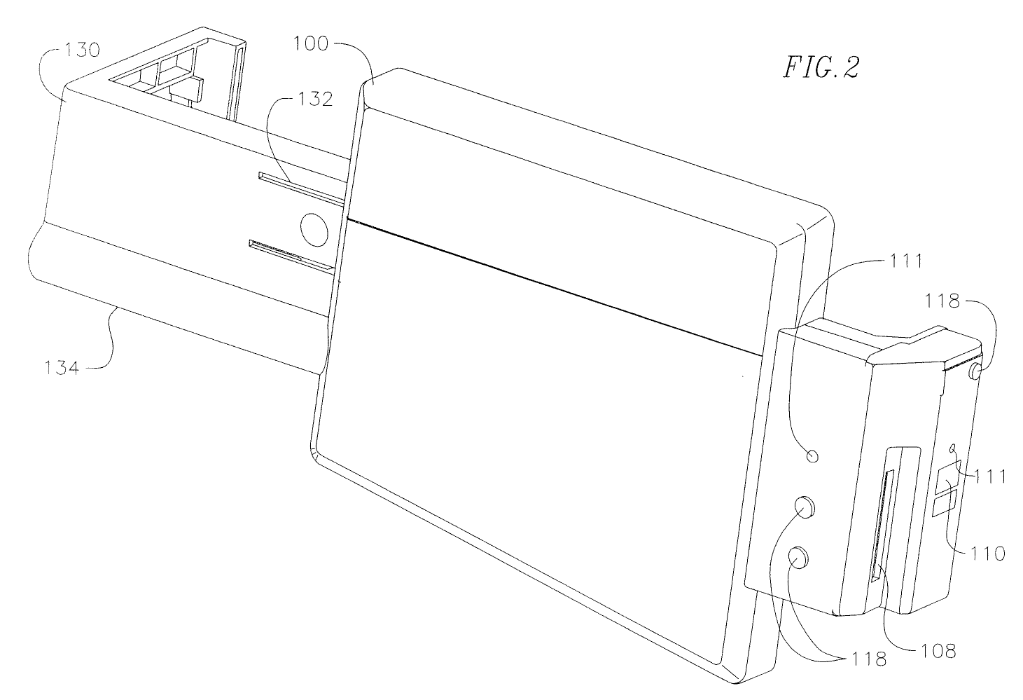

Referring now to the figures, and FIG. 1 in particular, in an exemplary embodiment according to present invention, a data drive 100 is provided. The data drive 100 interfaces with an external (electronic) device 200 through a memory card reader 208 using a connector 117 that emulates the physical and electronic connections of a memory card. The data drive 100 may be mounted on the external device 200, possibly with the use of a detachable mounting member 130 (shown in FIG. 2).

The external device 200 includes a controller 202 and a memory card reader 208. The memory card reader 208 and the controller 202 are external to the data drive 100, and are coupled to or are integral parts of the external device 200.

The external device 200 may be any suitable consumer electronics device, such as, for example, a video game console, such as the Nintendo Wii console. The memory card reader 208 may be any suitable memory card reader. In one embodiment, the memory card reader 208 is a Secure Digital (SD) card reader, but the present invention is not limited thereto.

The data drive 100 includes a hard disk drive (HDD) 104 and a controller 102 for controlling the HDD 104. The HDD stores images of memory cards, which are also referred to as pages. The controller 102 receives an external sync signal for synchronizing a page of the HDD 104. Data from this page can then be transferred between the HDD 104 and the external device 200 through the memory card reader 208. In one embodiment, the controller receives signals from control buttons 118 on the exterior of the data drive 100. These activate certain functions like synchronizing a page of the HDD, copying a memory card to the HDD 104, or confirming a command.

The data drive 100 can emulate a memory card to the memory card reader 208 when the data drive 100 is connected to the memory card reader 208 through the connector 117. In another embodiment, the controller 102 has the ability to reformat the HDD 104, for example, to a different block size, page size, or data organization. In still other embodiments, the storage device may not be a hard disk drive, but it may be any other suitable storage medium known to those skilled in the art. For example, the storage device in other embodiments may be a solid state drive (SSD). For the convenience of description, the data drive 100 will be described herein with an HDD as the storage device.

The data drive 100 also includes a display 110, which may include a liquid crystal display (LCD). The display 110 may, for example, display the page number for the hard disk drive area being accessed. As a possibility, if HDD 104 is a 100 gigabyte (100 GB) hard disk drive, a two-digit display may display between 00 and 99, each page corresponding to a gigabyte of disk space (the equivalent of a 1 GB memory card). The display 110 may be a monochrome or color display, and may be used to display other information for interface between the user and the data drive 100.

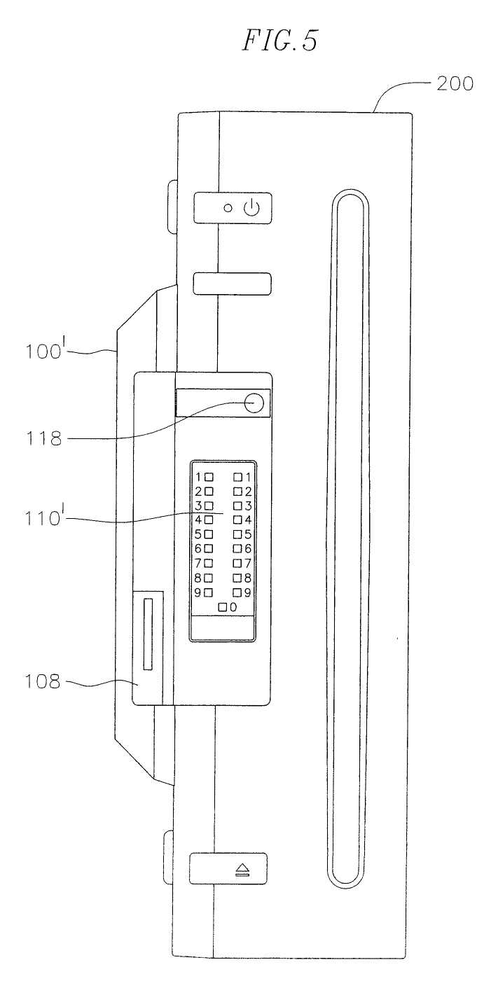

In other embodiments, the data drive may not include a liquid crystal display. As can be seen in FIG. 5, for example, a data drive 100′ includes a display 110′ that includes a number of light emitting diode (LED) indicators, each associated with a digit. Through the combination of digits next to the lighted LED indicators, the page number can be shown.

In addition to displaying page numbers, the display 110 includes one or more additional LEDs 111. Example functions for these LED indicators include indicating the status of the data drive 100 or an access indicator to notify when the HDD 104 is currently being accessed.

The data drive 100 also includes a memory card reader 108, which is used to read from and write to a memory card using a compatible format with the memory card reader 208 of the external device 200. In one embodiment, the memory card reader 108 can emulate the memory card reader 208 when the data drive 100 is connected to the memory card reader 208 through the connector 117. The memory card reader 108 receives instructions from the controller 102, possibly at the direction of control buttons 118, to transfer data between a memory card in the memory card reader 108 and the HDD 104. In one embodiment, the memory card reader 108 is a Secure Digital (SD) card reader, but the present invention is not limited thereto.

The data drive 100 also includes an interface unit 120. The interface unit 120, for example, together with the connector 117, make up a memory card adapter. The interface unit 120 interfaces between the HDD 104 and the memory card reader 208 of the external device 200 through the connector 117. As the data format for the HDD 104 is different from that of a memory card, the interface unit 120 converts the data format between that suitable for the HDD 104 and that which is compatible with the memory card.

The interface unit 120 includes a control interface 112, a switch 113, an HDD interface 114, a format converter 115, an external memory card interface 116, and an internal memory card interface 119. The external memory card interface 116 and the connector 117 may also be referred to as a “pseudo memory card,” for the external memory card interface 116 emulates the storage and logic of a memory card, while the memory card connector 117 emulates the physical and electronic connections of the memory card. This allows the pseudo memory card to connect physically to and interface electronically with the memory card reader 208. Consequently, the pseudo memory card substantially emulates the memory card to the memory card reader 208.

The internal card interface 119 is used to read from and write to the memory card reader 108 of the data drive. The HDD interface 114 is used to read from and write to the HDD 104. The external memory card interface 116 is used to read to and write from the memory card reader 208 through the connector 117. The format converter 115 converts a data format between the HDD data format and the memory card data format. The switch 113 serves as a hub for exchanging data between the different components, including the internal card interface 119, the HDD interface 114, the format converter 115, and the controller 102. The controller 102 controls the interface unit 120 through the control interface 112. The control interface 112 exchanges control information between the controller 102 and other interface unit components such as the internal card interface 119, the HDD interface 114, and the switch 113.

The data drive 100 also includes a power supply 150 that receives an external power to provide power to the memory card reader 108, the interface unit 120, the controller 102, the display 110, and the HDD 104. The power supply 150 may receive an external AC or DC power. The power supply 150 may include an AC/DC converter to convert an input AC power to DC power to provide to the components of the data drive 100.

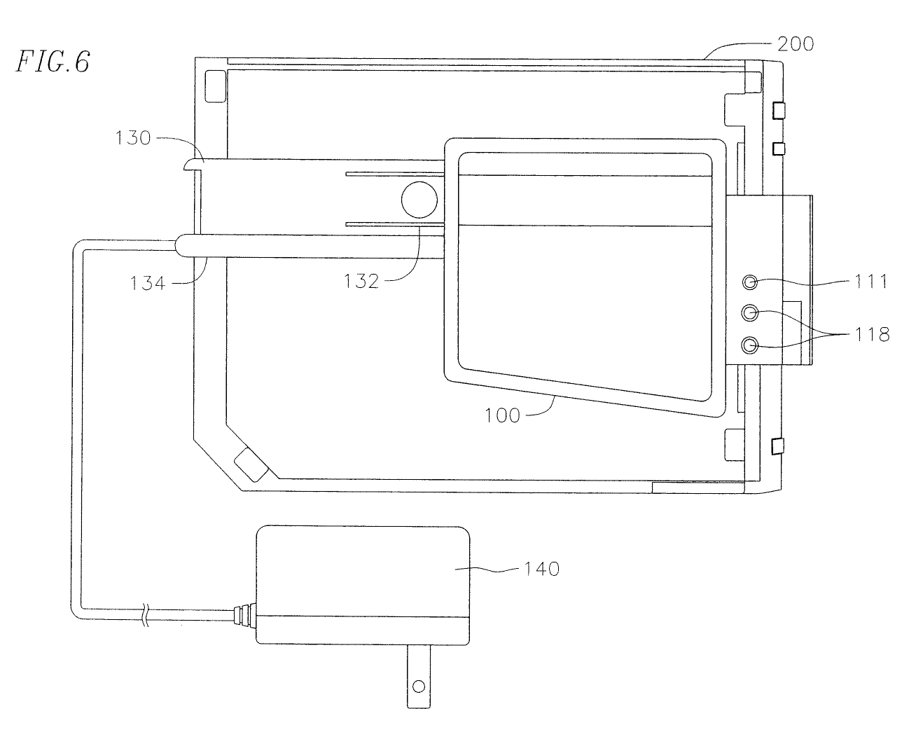

The external power may be received from an AC outlet (for AC power). For instance, FIG. 6 depicts an AC adapter 140 that converts AC power from a conventional AC power outlet to DC power for input through a power cord to the power supply 150. In other embodiments, the external power may be received from an electronic device, such as the external device 200. By providing an external power independent of the external device 200, the data drive 100 can continue to operate properly even when not connected to the external device or when the external device is turned off. The power supply 150 may also include a power storage device (e.g., rechargeable battery) instead of or in addition to other sources of power, such as an AC outlet or the external device 200. The power storage device may be used to power the data drive 100 when the other sources of power are not supplying power for a period of time (such as when traveling).

The data drive 100 may physically mount to the external device 200. A detachable mounting member 130 (see FIG. 2, for example) can facilitate this mounting. In one embodiment, the mounting member 130 includes a releasable locking tab 132 to facilitate attaching the mounting member 130 to or detaching the mounting member 130 from the data drive 100. In addition, the mounting member 130 may further include a power cord path 134 to help secure and hide the power cord attached to the adapter 140 used to deliver the external power to the data drive 100.

In operation, the external memory card interface 116 uses the connector 117 that has the form factor and external electrical connections of the desired memory card. This allows the connector 117 to be inserted into the memory card reader 208 of the external device 200 and thus, connect the memory card reader 208 of the external device 200 to the external memory card interface 116 of the data drive 100. The external device 200 may be a computer, camera, video game console, or any other suitable electronic device. The data drive 100 may mount to the external device 200 to further secure the connection, possibly with the aid of a detachable mounting member 130.

The pseudo-memory card (connector 117 and external memory card interface 116) is connected to the HDD 104 (e.g., through IDE, SATA, etc.) through the format converter 115, the switch 113, and the HDD interface 114. Because of this, the HDD 104 is able to read or write through the pseudo-memory card to the external device 200 through the memory card reader 208 using the connector 117. In essence, this allows the HDD 104 to communicate with another device (i.e., the external device 200) through the memory card reader 208 by emulating a memory card inserted into the memory card reader 208 of the other device.

The internal memory card interface 119 interfaces with the memory card reader 108 in the data drive 100 to transfer data between the HDD 104 and a memory card inserted in the data drive memory card reader 108. Here, the internal memory card interface 119 provides an interface between the memory card in the memory card reader 108 of the data drive 100 and the HDD 104 through the switch 113, the format converter 115, and the HDD interface 114. The format converter 115 converts the data format between a format that is compatible with the HDD 104 and the format that is compatible with the memory card. This way, the contents of the memory card inserted in the memory card reader 108 is copied easily for storage on the HDD 104.

In another embodiment, instead of or in addition to interfacing with the HDD 104, the memory card reader 108 emulates the memory card reader 208 when the data drive 100 is connected to the memory card reader 208 through the connector 117. This way, full functionality with the HDD 104 and the memory card reader 208 is maintained when the data drive 100 is connected to the memory card reader 208 through the connector 117. That is, a user can use the HDD 104 or a memory card inserted into the memory card reader 108 of the data drive to transfer data with the external device 200.

In one embodiment, the HDD 104 can be reformatted to have a different number of pages or organization. For example, a software driver in the controller in one embodiment allows the HDD 104 to be formatted to have higher capacity blocks, or larger or smaller pages.

In other embodiments, the HDD 104 in the data drive 100 can be connected to a Personal Computer (PC) or Macintosh computer (Mac) through a communication port 106 using an industry standard interface like Universal Serial Bus (USB), FireWire (Institute of Electrical and Electronics Engineers (IEEE) 1394), etc. This way, the files stored on the HDD 104 can also be stored on the computer, thereby allowing users to share with others (e.g., friends) using e-mail or other electronic communication methods. The communication port 106 links to the HDD 104 through the controller 102.

FIG. 2 is a perspective view of a data drive 100 in an exemplary embodiment according to the present invention. As can be seen in FIG. 2, the data drive 100 has a mounting member 130 for physically mounting the data drive 100 to an external electronic device 200.

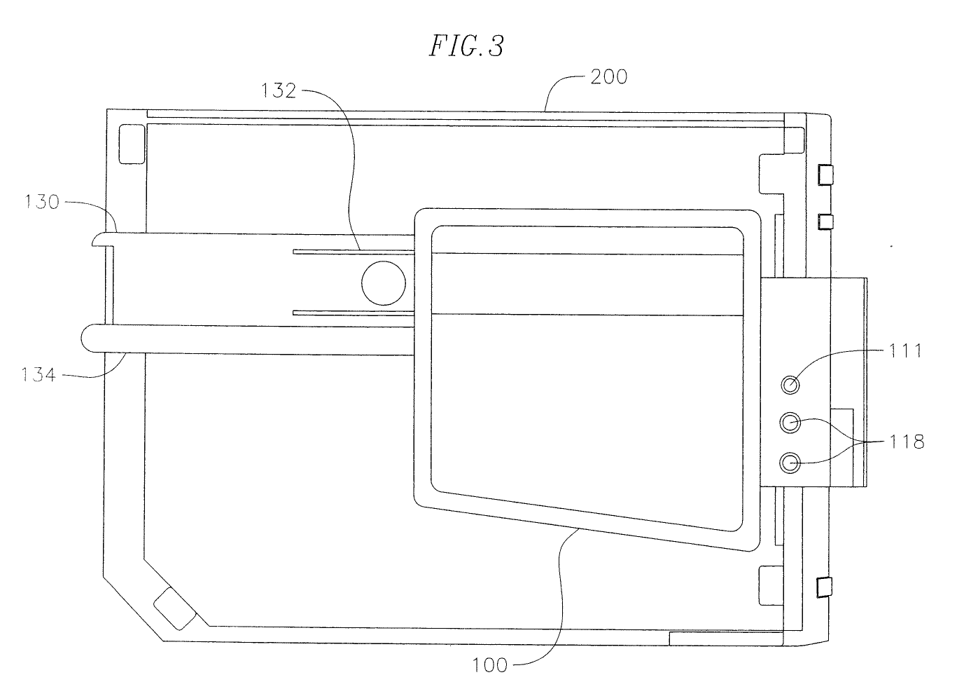

FIG. 3 is a side view of the data drive 100 of FIG. 2 mounted on an external electronic device 200. Here, the data drive 100 is mounted at a side of the external device 200 using the mounting member 130 to secure the data drive 100 from behind the external device 200. The releasable locking tab 132 allows the mounting member 130 to be securely attached to and quickly released from the data drive 100. The cord path 134 secures and conceals the AC power cord to the data drive 100. Some of the control buttons 118 and display LEDs 111 can also be seen from this view.

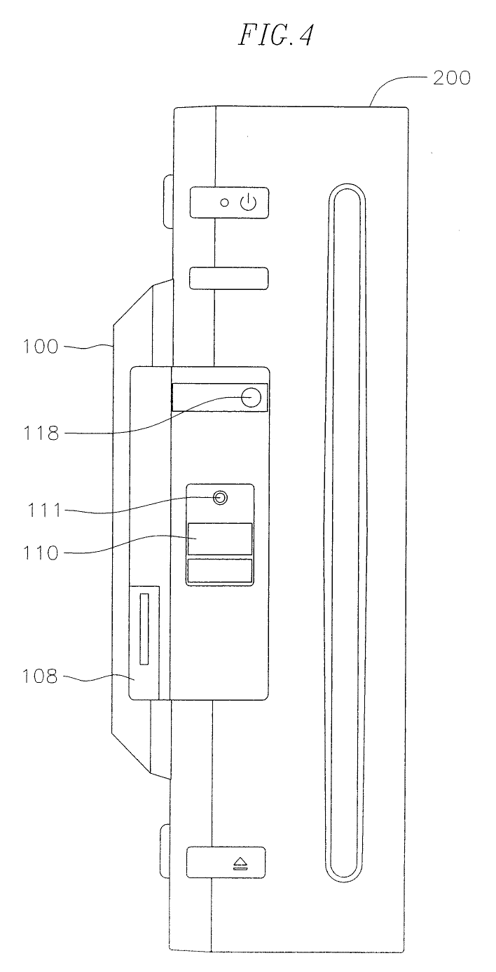

FIG. 4 is a front view of the data drive 100 of FIG. 2 mounted on an external electronic device 200. The external device 200 in this case is a Nintendo Wii console in one embodiment. However, the present invention is not limited thereto. A sync button 118 can be used to send a synchronization signal to the controller 102 to synchronize the HDD 104 to a particular page of storage (as though a memory card holding the contents of the page of storage was inserted in the memory card reader of the external device). The data drive 100 has a display 110 for showing a page number of the hard disk drive area being accessed, for example, as well as an access LED 111 to indicate when the HDD 104 is currently being accessed. The data drive 100 also has a memory card reader 108.

FIG. 5 is a front view of a data drive 100′ in another exemplary embodiment according to the present invention. In this embodiment, instead of the digital display 110 in FIG. 4, an alternative display 110′ including a number of light emitting diode (LED) indicators associated with digits is shown for indicating page numbers.

FIG. 6 is a side view of a data drive 100 coupled to an AC adapter 140 through a power cord in an exemplary embodiment according to the present invention. The data drive 100 is also depicted mounted to the external device 200 using a detachable mounting member 130 with a releasable locking tab 132 to secure the mounting member 130 to the remainder of the data drive 100. A power cord path 134 is provided to help secure and hide the power cord of the adapter 140.

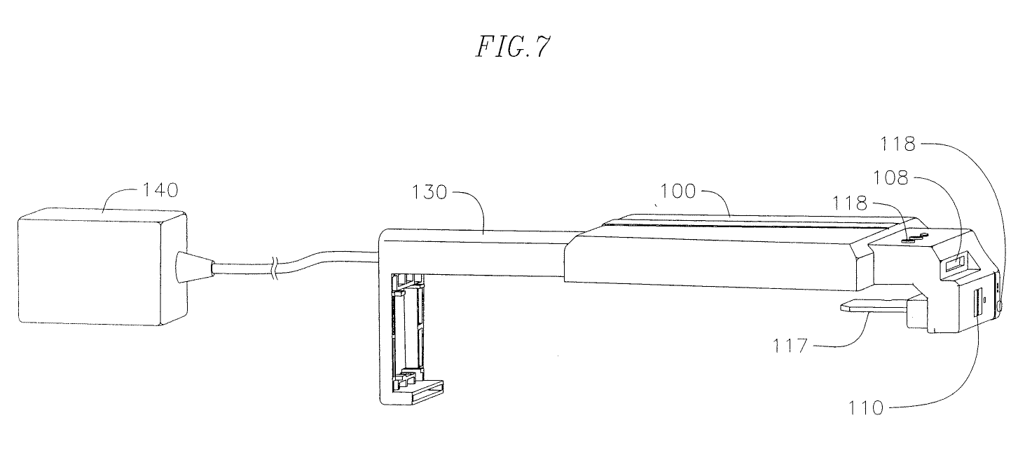

FIG. 7 is another side view of the data drive 100 of FIG. 6. As can be seen in FIG. 7, the physical memory card can be emulated by a memory card connector 117 that connects to an external device 200 (not shown) through a memory card reader 208. An AC adapter 140 with a power cord provides an independent power source for the data drive 100.

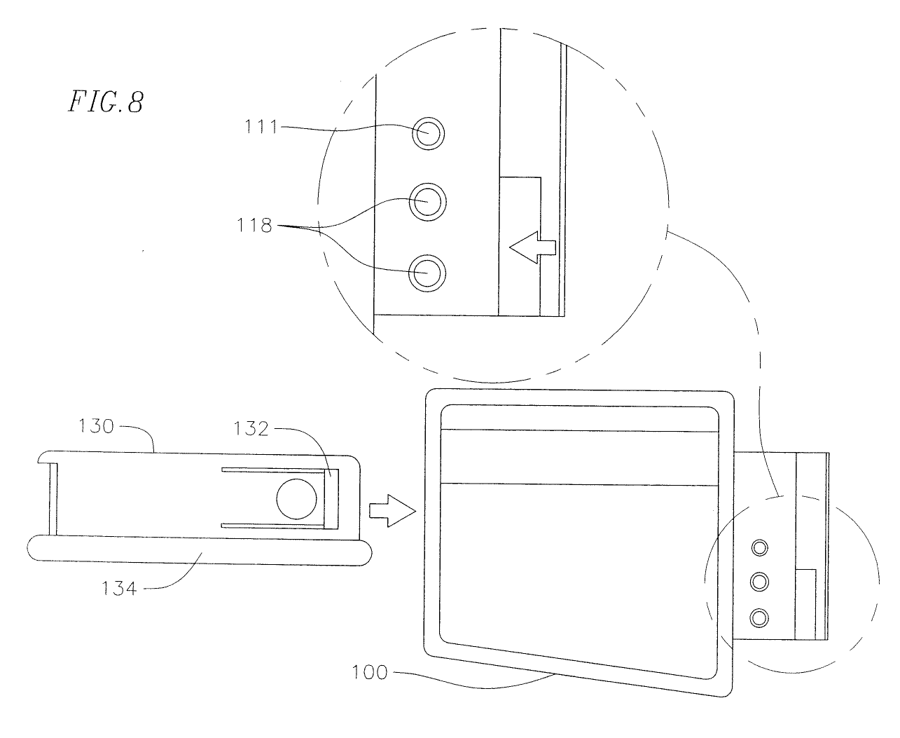

FIG. 8 is a schematic view of a data drive 100 having a two-part design in an exemplary embodiment according to the present invention. The two-part design allows for easy and secure assembly and removal of the data drive 100 from the external device 200 using a detachable mounting member 130. The mounting member 130 uses a releasable locking tab 132 to securely attach to and quickly detach from the data drive 100 for securing to the external device 200 (not shown).

Although certain exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data drive comprising:
a storage device for storing data having a second format;
an interface unit for converting a format of the data between a first format of a memory card and the second format, the interface unit comprising a device that is insertable into an external memory card reader to emulate the memory card; and
a controller for controlling data transfers between the storage device and the interface unit.

2. The data drive of claim 1, wherein the interface unit comprises a format converter for converting between the first format and the second format.

3. The data drive of claim 2, wherein the interface unit further comprises a first interface for interfacing with the storage device and a second interface for interfacing with the external memory card reader.

4. The data drive of claim 1, wherein the storage device comprises a hard disk drive.

5. The data drive of claim 1, wherein the external memory card reader is a Secure Digital (SD) card reader.

6. The data drive of claim 1, wherein the controller is adapted to control format conversion of the data between the first format and the second format.

7. The data drive of claim 1, further comprising a data drive memory card reader configured to transfer data between the memory card and the storage device.

8. The data drive of claim 7, wherein the interface unit interfaces between the data drive memory card reader and the storage device.

9. The data drive of claim 1, further comprising a data drive memory card reader configured to emulate the external memory card reader when the interface unit device is inserted into the external memory card reader.

10. The data drive of claim 1, further comprising a display for user interface.

11. The data drive of claim 10, wherein the display is adapted to display a page number for an area of the storage device being accessed.

12. The data drive of claim 10, wherein the display comprises light emitting diodes (LEDs) to indicate a status of the data drive.

13. The data drive of claim 1, wherein the controller is configured to receive an external synchronization signal for synchronizing a memory card image to the storage device.

14. The data drive of claim 1, further comprising a communication port to communicate with an external device.

15. The data drive of claim 14, wherein the communication port comprises a serial bus interface, a Universal Serial Bus (USB) port, or a FireWire interface.

16. The data drive of claim 1, wherein the controller is configured to receive control commands from control buttons on an exterior of the data drive.

17. The data drive of claim 1, further comprising a power supply for receiving an external power, and using the external power to provide power to the storage device, the interface unit, and the controller.

18. The data drive of claim 17, further comprising a power cord for delivering the external power.

19. The data drive of claim 18, further comprising a detachable mounting member used to facilitate mounting the data drive to an external device, wherein the mounting member comprises a power cord path to help secure and hide the power cord.

20. The data drive of claim 1, wherein the data drive interfaces with an external device through the external memory card reader and the insertable device comprises a connector that emulates physical and electronic connections of the memory card.

21. The data drive of claim 20, wherein the data drive is mountable on the external device.

22. The data drive of claim 21, further comprising a detachable mounting member to facilitate mounting on the external device.

23. The data drive of claim 22, wherein the mounting member comprises a releasable locking tab to facilitate attachment to and detachment from a remainder of the data drive.

24. The data drive of claim 20, wherein the external device is a video game console.

25. A method of transferring data between a storage device and an external device having a memory card reader, the memory card reader for transferring data having a first format, the storage device for transferring data having a second format, the method comprising reading and storing,
wherein the reading comprises:
reading first data having the second format from the storage device;
converting the first data having the second format into first data having the first format; and
storing the first data having the first format to the external device through the memory card reader,
and the storing comprises:
reading second data having the first format from the external device through the memory card reader;
converting the second data having the first format into second data having the second format; and
storing the second data having the second format to the storage device.

26. A method of emulating a memory card to a memory card reader using a storage device, the memory card for storing data having a first format, the storage device for storing data having a second format, the method comprising:
coupling the storage device to the memory card reader using a connector emulating physical and electronic connections of the memory card; and
interfacing the storage device with the connector, wherein the interfacing comprises converting a format of data between the first format and the second format.
